(19) United States
(12) Patent Application Publication
(10) Pub. No.: US 2019/0203691 A1
(43) Pub. Date: Jul. 4, 2019

(54) WIND COLLECTION APPARATUS AND WIND POWER GENERATION EQUIPMENT

(71) Applicant: NGUYEN CHI CO., LTD., Ho Chi Minh City (VN)

(72) Inventor: Nguyen Thanh LE, Ho Chi Minh City (VN)

(73) Assignee: NGUYEN CHI CO., LTD., Ho Chi Minh City (VN)

(21) Appl. No.: 16/328,046

(22) PCT Filed: Aug. 25, 2017
(86) PCT No.: PCT/JP2017/030453

§ 371 Date: Feb. 25, 2019

(30) Foreign Application Priority Data
Aug. 25, 2016 (JP) 2016-164500

(51) Int. Cl. F03D 1/04; F03D 9/25; E04B 1/34

(52) U.S. Cl. CPC F03D 1/04; F03D 1/025; E04B 1/3404; F03D 9/25

(57) ABSTRACT

The wind collection apparatus has a wind collecting section for collecting wind taken from a front surface side into a wind outlet. The wind outlet is provided below an upper end of the front surface of the wind collecting section. The wind collecting section is configured such that a cross section of wind flow passage becomes smaller from the front surface side toward the rear surface side. The wind collecting section has a pair of left and right side wall portions, and an upper wall portion bridged between the pair of side wall portions. A plurality of support columns are arranged to penetrate the upper wall portion. The upper end portion of each support column and the upper wall portion are connected to each other by cables, and upper wall portion is suspended by the cables.

### TECHNICAL FIELD

The present invention relates to wind collection apparatus and wind power generation equipment.

### BACKGROUND ART

In recent years, due to an increased awareness of environment, a wind power generation device has attracted public attention as a renewable energy type power generation device. A compact wind power generation device can be installed basically anywhere where there is wind.

For this reason, buildings such as those having particularly high power supply needs, as supplementary power supply equipment for supplying power to ancillary facilities such as facilities for lighting common parts of buildings, and for use as supplementary power supply equipment in case of power failure or the like, wind power generation device is usually expected to be installed in the surroundings of a building and the roof thereof.

One example of a wind collection apparatus for efficiently operating a windpower generation device by effectively utilizing a wind flowing through the roof of a building, has been described in Patent Literature 1.

This wind collection apparatus is provided on the roof of a building and includes a lower wind-collecting structure and an upper wind-collecting structure, each having an approximately the same shape as the roof itself in a plan view.

The lower wind-collecting structure is provided such that the roof part of the building is covered in a gentle arcuate surface shape with a convex part having a flat and horizontal surface at the center part thereof and facing upward. The upper wind-collecting structure is disposed above the lower wind-collecting structure, and is substantially symmetrical with respect to the lower wind-collecting structure in the vertical direction.

A vertical axis type wind power generation device is arranged in a space surrounded by the afore-mentioned flat surface between the lower wind-collecting structure and the upper wind-collecting structure.

### CITATION LIST

### Patent Document

Patent Document 1: Japanese Patent Application Laid-Open No. 2014-34889

### SUMMARY OF THE INVENTION

### Technical Problems

On the other hand, the above-mentioned conventional wind collection apparatus is installed on the roof of a building, and electricity is generated by a vertical shaft type wind power generation device, using a wind collected by the wind collection apparatus. In this way, an electric power can be supplied to equipment or the like in the building.

Accordingly, such a conventional wind collection apparatus is not suitable for use with a relatively large-size wind power generation device capable of supplying electricity to an entire district area. In other words, since the wind collection apparatus is compact, it is not suitable to be used for a large-size wind power generation device.

However, if the wind collection apparatus is enlarged, the elements constituting a wind collecting section for wind collection will also become large, resulting in an increased weight of the wind collection apparatus, making it impossible to easily increase the size of the wind collection apparatus. Moreover, if a wind collection apparatus is enlarged in its size, there is also a problem that the elements constituting the wind collecting section are likely to be deflected downwardly due to their weights, so that it is difficult to efficiently collect the wind. In addition, when a large-size wind collection apparatus is made, it is also necessary to efficiently collect the wind received on the front side of the wind collection apparatus into the outlet port thereof, and to discharge the collected wind therefrom.

The present invention has been accomplished in view of the above circumstances, and it is an object of the present invention to provide a wind collection apparatus capable of easily enlarging its size and effectively collecting and discharging a wind. It is another object of the present invention to provide a wind power generation equipment equipped with such wind collection apparatus.

### Solution to the Problems

In order to arrive at the above object, a wind collection apparatus of the present invention comprises a wind collecting section for collecting wind taken from a front surface side into an outlet provided on a rear surface side, wherein the outlet is provided below an upper end of the front surface of the wind collecting section; the wind collecting section is configured such that a cross section of wind flow passage becomes smaller from the front surface side toward the rear surface side; the wind collecting section has a pair of left and right side wall portions and an upper wall portion bridged between the pair of side wall portions; a plurality of support columns are arranged to penetrate the upper wall portion; upper end portion of each support column and the upper wall portion are connected to each other by cables; and upper wall portion is suspended by the cables.

In the present invention, the flow of the wind volume in the natural environment is reduced (wind cutting) on the front side of the wind collecting section, collected to the rear side, and sent out therefrom. Then, since the wind outlet is provided below the upper end of the front surface of the wind collecting section and the cross section of the wind collecting section becomes smaller from the front side toward the rear side, the height of the wind is reduced, and the volume of the normal pressure wind will be narrowed down to a high density and a high pressure wind, followed by being efficiently discharged from the wind outlet.

In addition, since the upper wall portion of the wind collecting section is suspended by the cables connected to the support columns, it is possible to control the deflection of the upper wall portion and exactly support the same. Therefore, it becomes easy to enlarge the wind collection apparatus.

Further, according to the above configuration of the present invention, the pair of side wall portions are arranged to be closer to each other from the front surface side toward the rear surface side; and the upper wall portion is disposed to be inclined downward from the front surface side toward the rear surface side.

With such a configuration, the pair of right and left side wall portions and the upper wall portion make it easy to provide the wind outlet below the upper end of the front surface of the wind collecting section, and easily set the cross section of flow passage of the wind collecting section in a manner such that it becomes smaller from the front side toward the rear side.

According to the above configuration of the present invention, the upper wall portion includes a plate-like upper wall main body and a support frame fixed to an upper surface of the upper wall main body; and cables are connected to the support frame.

According to the above configuration, since the upper wall main body can be reinforced by the support frame, the thickness of the upper wall main body can be inhibited so as to reduce the weight thereof, thus making it easy to connect cables to the upper wall portion.

Further, the wind power generation equipment of the present invention, comprises a wind collection apparatus; and wind power generation device connected to the wind outlet of the wind collection apparatus.

In the present invention, since the wind collecting section of the wind collection apparatus can reduce the height of the wind, narrow down the volume of the normal pressure wind to a high density and a high pressure wind, it is possible to efficiently generate electricity using wind and the wind power generation device.

Further, according to the above configuration of the present invention, it is possible to reach the following arrangements which can be conclude as follows.

The wind power generation device includes: a cylindrical body; a shaft portion provided inside the cylindrical body in an axial direction of the cylindrical body; and a plurality of impellers which are coaxial with the shaft portion and provided inside the cylindrical body in the axial direction of the shaft portion.

Each impeller includes: a cylindrical support member supported by a shaft portion by inserting the shaft portion; a rotary body rotatably provided on the support member around the shaft via a bearing; and a plurality of blades provided on an outer peripheral portion of the rotary body.

A permanent magnet is provided on one of the support member and the rotary body, and a coil is provided on the other of the support member and the rotary body, with a predetermined gap formed between the coil and the permanent magnet.

According to the above configuration, since a plurality of impellers are provided inside the cylindrical body, the impellers are rotated efficiently by allowing the wind to flow into the inside of the cylindrical body, thereby effecting a power generation through a collaboration between the permanent magnet and coils. As a result, the blades can be made smaller than conventional wind power generation equipment, so that they can be installed in a space-saving manner. In addition, the cylindrical body is less susceptible to the influence from the surrounding wind, can suppress noise, and it also gives good appearance in its outside appearance.

In addition, since the impellers are provided inside the cylindrical body, the wind (air) hitting the impellers will not escape to the outside, so that the wind pressure does not decrease. Further, since the wind efficiently hits all impellers, it is possible to efficiently generate electricity.

Moreover, since each impeller includes the support member supported by the shaft portion and the rotary body which is rotatably provided via the bearing on the support member and in which the blades are provided on its outer peripheral portion, it is possible to easily increase or decrease the number of impellers provided on the shaft portion. Therefore, it is possible to easily adjust the ability of the windpower generation equipment in response to a wind force or a wind amount.

### Effects of the Invention

According to the wind collection apparatus of the present invention, the wind outlet is provided below an upper end of the front surface of the wind collecting section. The wind collecting section is configured such that a cross section of wind flow passage becomes smaller from the front surface side toward the rear surface side. The wind collecting section has a pair of left and right side wall portions and an upper wall portion bridged between the pair of side wall portions. A plurality of support columns are arranged to penetrate the upper wall portion. The upper end portion of each support column and the upper wall portion are connected to each other by cables, and upper wall portion is suspended by the cables. In this way, so that the wind collection apparatus can be easily made large and efficiently collect and discharge a wind.

Further, according to the wind power generation equipment of the present invention, since the equipment includes the wind collection apparatus and the wind power generation devices connected to the wind outlet of the wind collection apparatus, it is possible to efficiently generate an electricity.

### BRIEF DESCRIPTIONS OF THE DRAWINGS

FIG. 1 is a perspective view seen from the front side, showing a wind collection apparatus according to an embodiment of the present invention,

FIG. 2 is a perspective view seen from the rear side.

FIG. 3 is a perspective view showing essential parts.

FIG. 4 is a side view showing the essential parts.

FIG. 5 is a perspective view showing wind power generation equipment according to an embodiment of the present invention.

FIG. 6 is a perspective view showing an assembly of wind power generation units.

FIG. 7 is a perspective view showing a wind power generation unit according to an embodiment of the present invention.

FIG. 8 is a perspective view showing the inside of a wind power generation unit.

FIG. 9 is a perspective view showing an impeller of a wind power generation unit.

FIG. 10 is a cross-sectional view of the impeller.

### DESCRIPTION OF EMBODIMENTS

Hereinafter, embodiments of the present invention will be described with reference to the drawings.

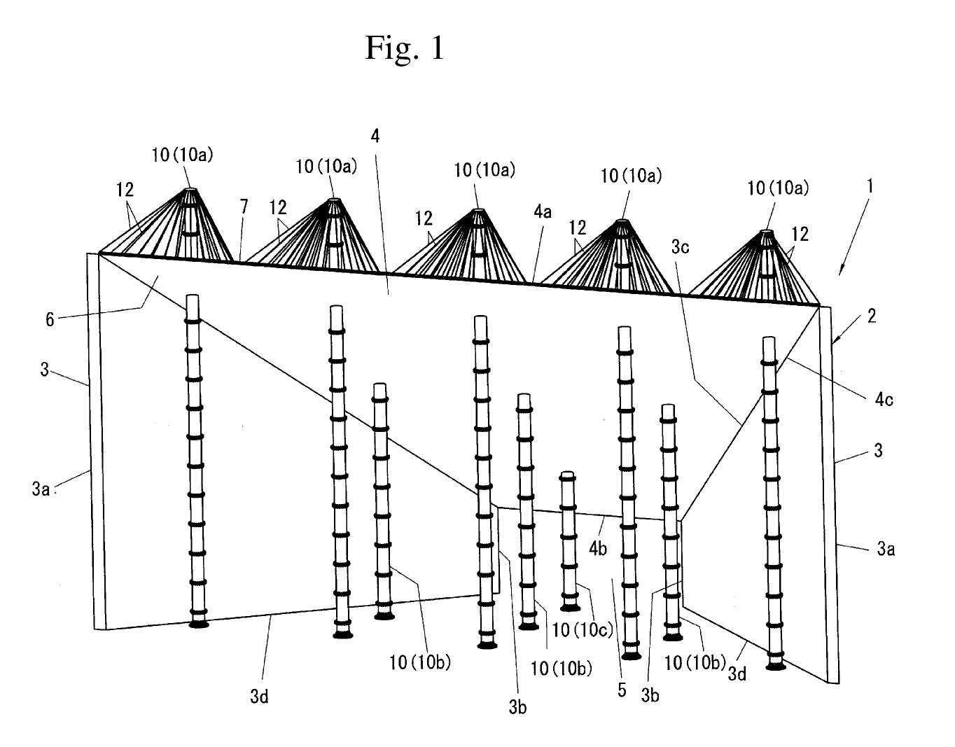

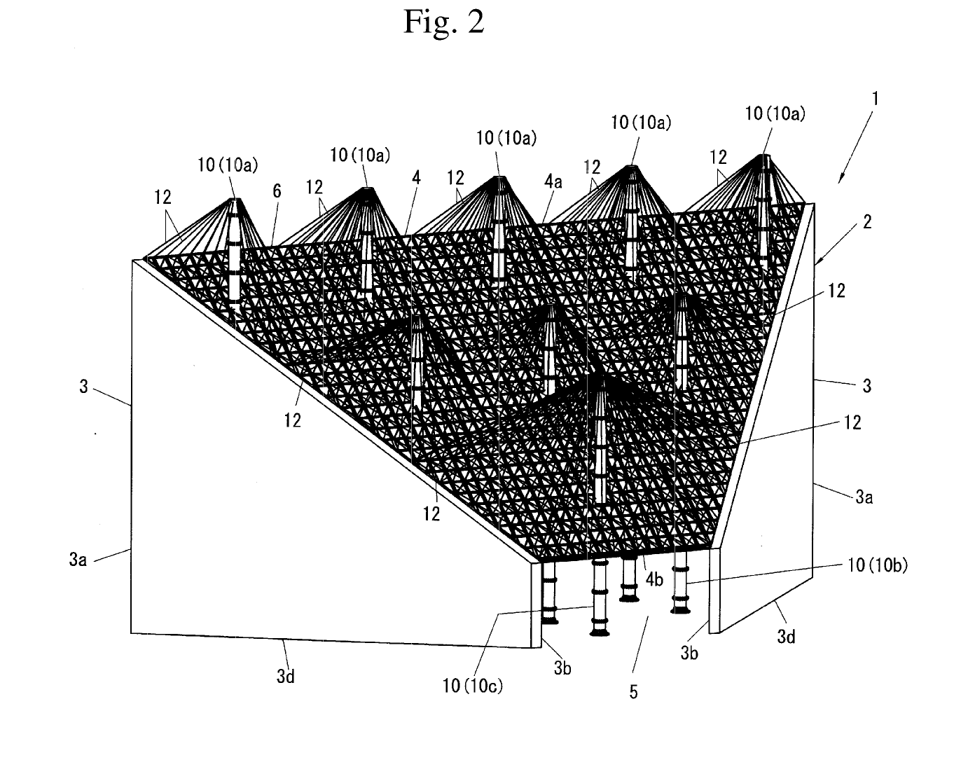

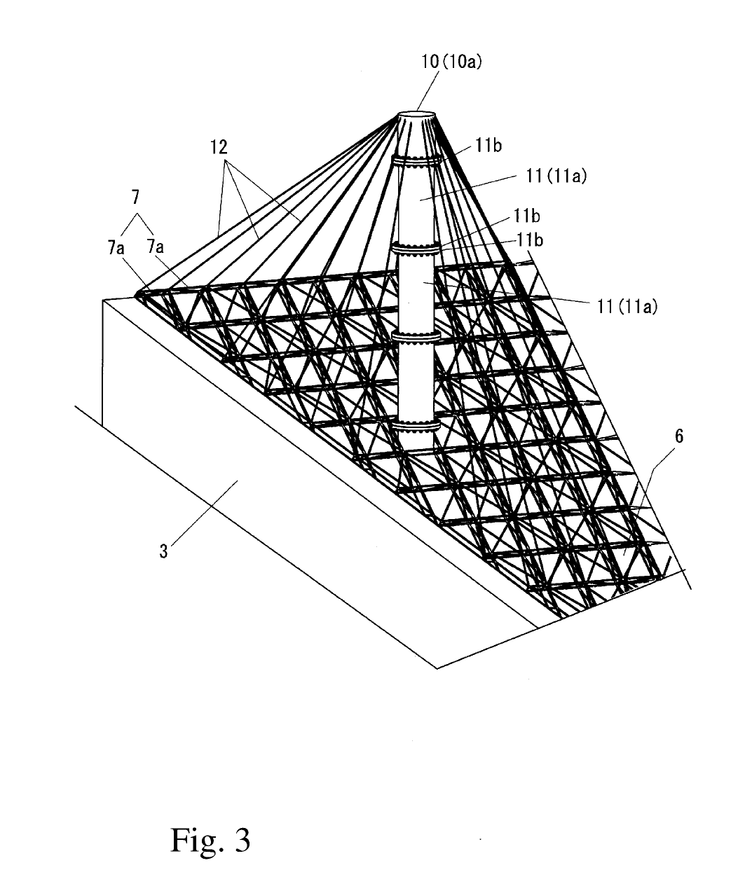

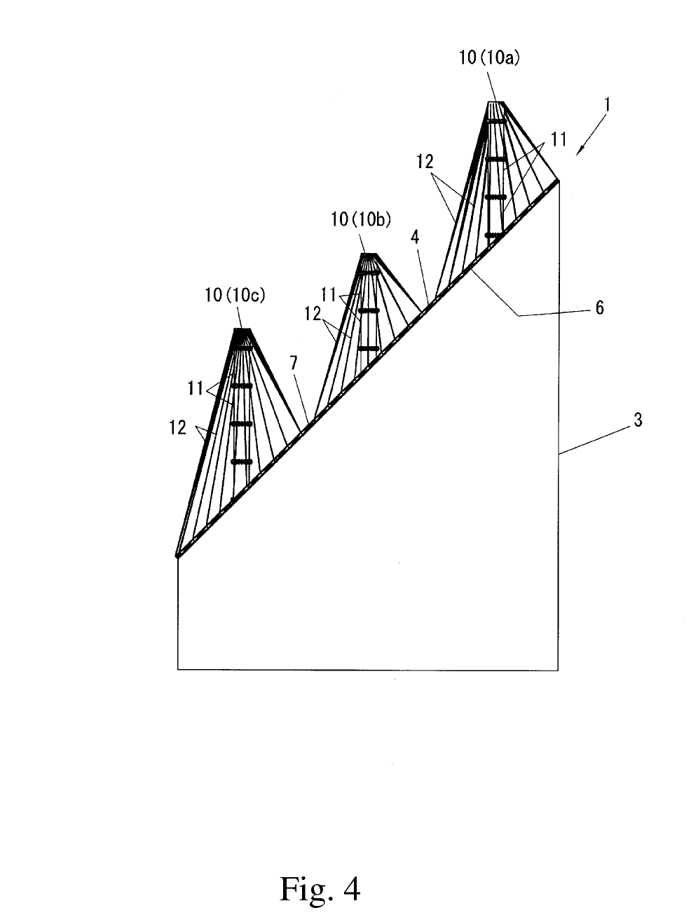

FIG. 1 is a perspective view seen from the front side, showing a wind collection apparatus 1 of the present invention. FIG. 2 is a perspective view seen from the rear side, FIG. 3 is a perspective view showing essential parts, FIG. 4 is a side view.

As shown in FIGS. 1-4, the wind collection apparatus 1 includes a wind collecting section 2. The wind collecting section 2 has a pair of left and right side wall portions 3, 3 and an upper wall portion 4 bridged between the pair of side wall portions 3, 3.

The side wall portions 3, 3 are each formed into a trapezoidal shape, and mutually opposed vertical side portions (right and left side portions) 3a, 3b are parallel to each other. The vertical side portion 3b is shorter than the vertical side portion 3a. In addition, upper side portions 3c are inclined with respect to the horizontal plane, while lower side portions 3d are horizontal and arranged perpendicularly to the vertical side portions 3a, 3b.

The upper wall portion 4 is formed into a trapezoidal shape, an upper side portion 4a and a lower side portion 4b facing each other are parallel to each other, and the lower side portion 4b is shorter than the upper side portion 4a. In addition, left and right side portions 4c, 4c are inclined at the same angle with respect to the horizontal plane. The inclining angles of the left and right side portions 4c, 4c are equal to the inclining angles of the upper side portions 3c of the side wall portions 3.

The pair of side wall portions 3, 3 are disposed to be closer to each other from the front side of the wind collecting section 2 toward the rear side thereof, and the upper wall portion 4 is disposed to extend downwardly from the front side of the wind collecting section 2 toward the rear side thereof.

The upper side portions 3c, 3c of the side wall portions 3 are connected to the left and right side portions 4c, 4c of the upper wall portion 4, while a wind outlet 5 is formed by being surrounded by the vertical side portions 3b, 3b of the side wall portions 3 and the lower side portion 4b of the upper wall portion 4, as well as the ground surface.

The wind outlet 5 is provided on the front side of the wind collecting section 2, i.e., below the upper side portion 4a of the upper wall portion 4.

Further, by disposing the pair of side wall portions 3, 3 and the upper wall portion 4 as described above, the wind collecting section 2 can be arranged such that the cross-section of the flow passage becomes narrower from the front side toward the rear side.

The side wall portions 3 are formed of, for example, plate-like members made of reinforced concrete, but this should not be limited thereto. For example, the side wall portions 3 may also be formed by joining a plurality of wall panels or by bonding together a plurality of structural plywood. Here, the wall panel may be composed of, for example, a frame body and structural plywood attached to both the front and back surfaces of the frame body.

Further, when the side wall portions 3 are formed of plate-like members made of reinforced concrete, the side wall portions 3 may be formed by striking on site or by manufacturing a plurality of precast reinforced concrete plates in a factory or the like, followed by joining these plates on site.

The upper wall portion 4 includes a trapezoidal plate-like upper wall main body 6 and a support frame 7 fixed to the upper surface of the upper wall main body 6.

The upper wall main body 6 is formed into a trapezoidal plate by bonding a plurality of metal plates or roofing materials or structural plywood.

The support frame 7 is formed by stacking, at a predetermined interval in the thickness direction of the upper wall portion 4, two trapezoidal planar frames 7a, 7a formed by vertically and horizontally assembling a plurality of rod-shaped steel materials in a grid pattern, followed by connecting these planar frames 7a, 7a using steel material. The support frame 7 and the upper wall main body 6 are trapezoidal, having almost the same size in plan view.

Then, after the support frame 7 is stacked on the upper surface of the upper wall main body 6, the support frame 7 is fixed to the upper surface of the upper wall main body 6.

Further, the wind collection apparatus 1 is provided with a plurality of (for example, nine) support columns 10. All of the support columns 10 vertically penetrate through the upper wall portion 4, while the lower end portions of the support columns 10 are fixedly installed on the ground. In detail, foundations are provided on the ground, and the lower end portions of the support columns 10 are fixedly installed on these foundations.

Nine support columns 10 in all are so arranged that five of them are disposed at equal intervals in the right/left direction on the upper portion of the obliquely disposed upper wall portion 4, three of them are disposed at equal intervals in the right/left direction on the central portion thereof, and one of them is disposed at the right/left center of the lower portion.

The upper five columns 10a (10), the three central columns 10b (10), and the one lower column 10c (10) are different from each other in their vertical lengths. In more detail, the vertical lengths of these support columns are so set that the following relation can be established: columns 10a>columns 10b>column 10c.

Further, as shown in FIG. 3, each support column 10 is formed by joining a plurality of steel cylindrical members 11 in the axial direction. Each cylindrical member 11 is composed of a cylindrical body 11a and flange portions 11b provided at both end portions of the cylindrical body 11a.

When joining the cylindrical members 11 in the axial direction, the cylindrical members 11, 11 are disposed coaxially, and the flange portions 11b, 11b are butted against each other, followed by fastening the flange portions 11b, 11b using bolts. On the other hand, the cylindrical member 11 at the upper end of each support column 10 has no flange portion 11b at the upper end thereof, and the flange portion 11b is provided only at the lower end portion thereof. Moreover, in the cylindrical member 11 at the lower end of each support column 10, reinforcing ribs are provided in the flange portion 11b at the lower end portion of the cylindrical member 11, at predetermined intervals along the circumferential direction.

The upper end portion of each support column 10 and the upper wall portion 4 are connected by cables 12 made of an iron wire, a steel wire, or the like.

Namely, a plurality of cables 12 are arranged radially in plan view at a predetermined interval in the circumferential direction at the upper end portion of the support column 10, and the upper end of each cable 12 is connected to the upper end portion of the support column 10. Further, the lower ends of the respective cables 12 are arranged away from the support column 10 in the radial direction, and the lower ends of the respective cables 12 are connected to the support frame 7 constituting the upper side of the upper wall portion 4.

Each cable 12 is tightly connected to the support frame 7, so that the upper wall portion 4 is suspended by the cables 12.

Using the wind collection apparatus 1 having the above-described configuration, the flow of the wind volume in the natural environment will be reduced (wind reduction) on the front side of the wind collecting section 2, and the wind will be collected into the rear side of the wind collecting section 2. Here, since the wind outlet 5 is provided below the upper end of the front surface on the front side of the wind collecting section 2, and the cross-section of the wind flow passage of the wind collecting section 2 becomes narrower from the front side to the rear side, it is possible to effectively discharge the wind from the wind outlet 5 after reducing the height of the wind and squeezing the volume of the wind at the normal pressure into a volume at a high density and a high pressure.

In addition, since the upper wall portion 4 of the wind collecting section 2 is suspended by the cables 12 connected to the support columns 10, it is possible to exactly support the upper wall portion 4 with its deflection suppressed. Therefore, it is easy to increase the size of the wind collection apparatus 1.

The wind collecting section 2 has a pair of right and left side wall portions 3, 3 and an upper wall portion 4 bridged between the pair of side wall portions 3, 3. The pair of side wall portions 3, 3 are disposed to be closer to each other from the front side to the rear side of the wind collecting section 2. The upper wall 4 is disposed to be inclined downward from the front side to the rear side of the wind collecting section 2. Accordingly, it is possible to easily provide the wind outlet 5 below the upper end of the front surface of the wind collecting section 2 and to easily make smaller the cross section of the flow passage in the wind collecting section 2 from the front side to the rear side.

The upper wall portion 4 includes a plate-like upper wall main body 6 and a support frame 7 fixed to the upper surface of the upper wall main body 6, and the cables 12 are connected to the support frame 7. Therefore, since the upper wall main body 6 can be reinforced by the support frame 7, it is possible to inhibit the thickness of the upper wall main body 6, thus reducing the whole weight of the wind collecting section. Meanwhile, it becomes easy to connect the cables 12 to the upper wall portion 4.

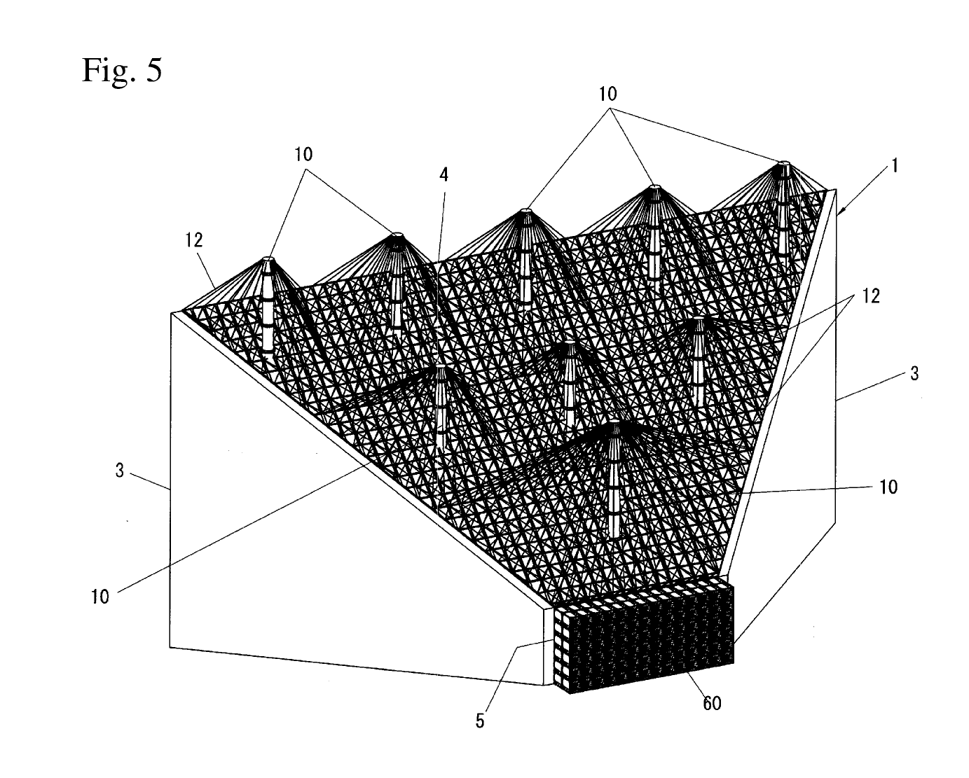

FIG. 5 is a perspective view showing a wind power generation equipment which includes the wind collection apparatus 1 as described above and the wind power generation unit assembly 60 connected to the wind outlet 5 of the wind collection apparatus 1.

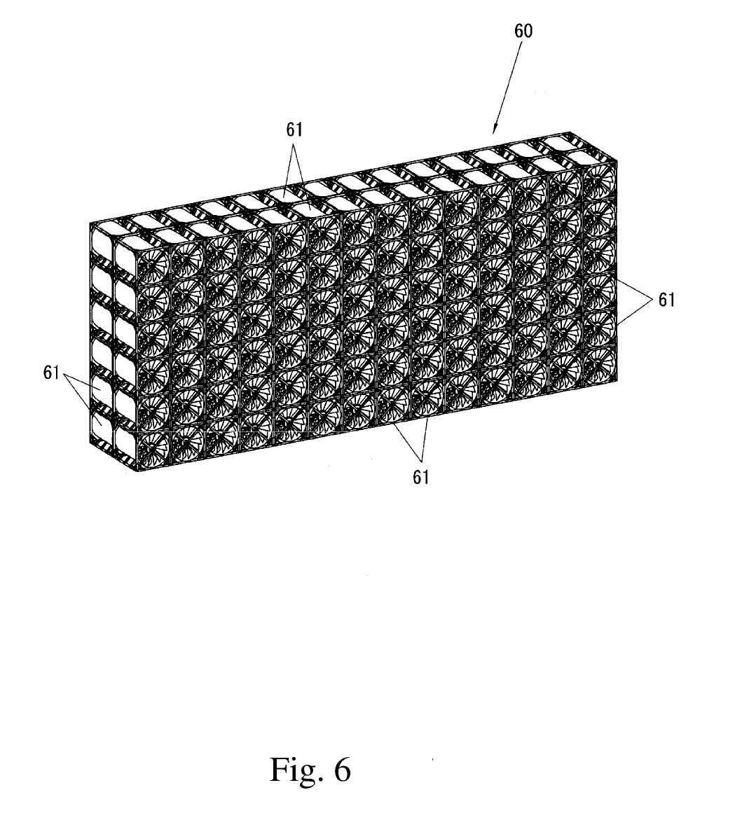

As shown in FIG. 6, the wind power generation unit assembly 60 is constituted by a plurality of wind power generation units 61 stacked in the thickness direction and arranged vertically and horizontally into a matrix pattern.

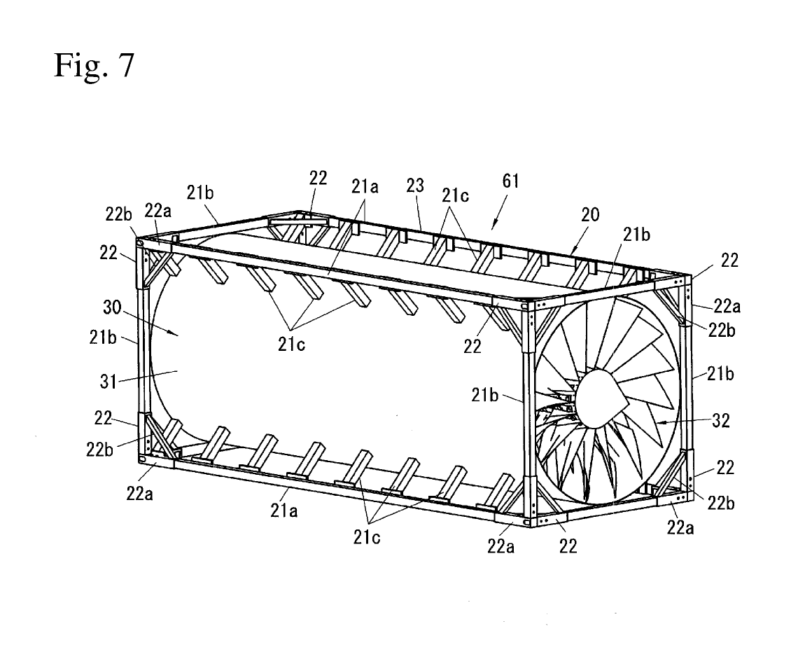

As shown in FIG. 7, each wind power generation unit 61 includes a storage unit 20 in a rectangular parallelepiped frame shape and a wind power generation device 30 housed in the storage unit 20.

The storage unit 20 includes a frame body 23 and a plurality of reinforcing structural members 21c. The frame body 23 is in the form of a rectangular parallelepiped frame shape assembled by connecting four rod-like structural members 21a and eight rod-like structural members 21b using a plurality of structural member joints 22. The plurality of reinforcing structural members 21c are arranged inside the frame body 23 and inclined at an angle with respect to the structural members 21a.

The structural members 21a-21c are formed by square pipes having the same cross sectional shape, and the four long structural members 21a constitute four long sides of the frame body 23. The eight shore structural members 21b are disposed between the ends of the four long structural members 21a.

The structural material joints 22 are used to connect the rod-shaped structural members 21a, 21b and each has three joint members 22a capable of inserting and fixing the end portions of the structural members 21a, 21b. Each joint member 22a is formed in a square tetragonal shape, and their base ends are joined to each other by, for example, welding, adhesion, or the like. Further, the three joint members 22a are disposed at right angles to each other, and connected by reinforcing members 22b.

Such joint members 22a are disposed at the eight corners of the storage unit 20, and a plurality of structural members 21a, 21b are connected into a rectangular parallelepiped shape by the structural member joints 22, thus forming an assembled storage unit 20.

Further, a square frame is formed of the four structural members 21a using the structural material joints 22, and this square frame constitutes the end face of the frame body 23. In FIG. 7, the right side square frame constitutes the front end face of the frame body 23, and the left side square frame constitutes the rear end face of the frame body 23.

The structural members 21c are disposed to be inclined with respect to the structural members 21a and to penetrate through a cylindrical body 31 which constitutes an outer shell for the wind power generation device 30. One end of each structural member 21c is fixed to one structural member 21a, while the other end thereof is fixed to a support member 33 or a shaft 25 (which will be described later) of the wind power generation device 30. In addition, the structural members 21c are arranged in a substantially X-shape when viewed from the front end of the storage unit 20, and the support member 33 or the shaft 25 is supported by the intersections of X-shaped arrangement of structural members 21c.

As shown in FIGS. 7-10, the wind power generation device 30 includes a cylindrical body 31, a shaft section 25 provided in the cylindrical body 31 along the axial direction of the cylindrical body 31, and a plurality of impellers 32 that are provided inside the cylindrical body 31, coaxial with the shaft 25 and located along the axial direction of the shaft 25.

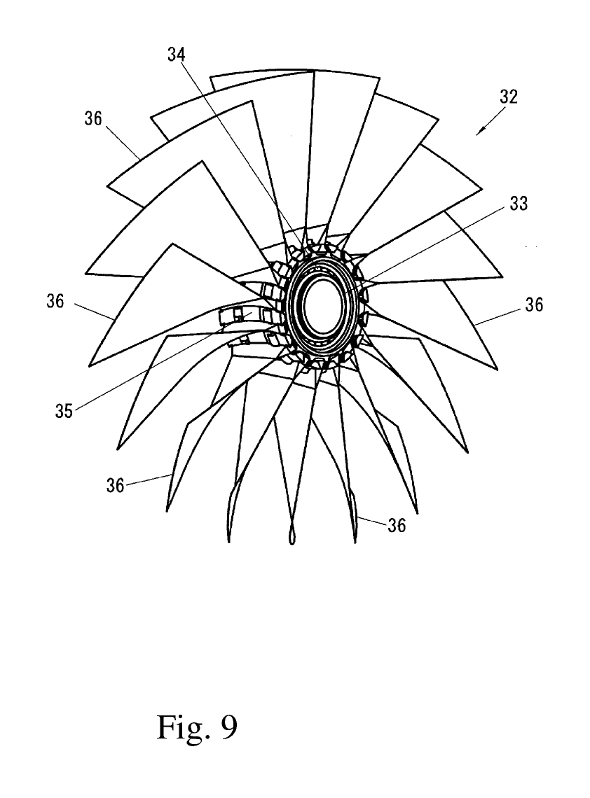

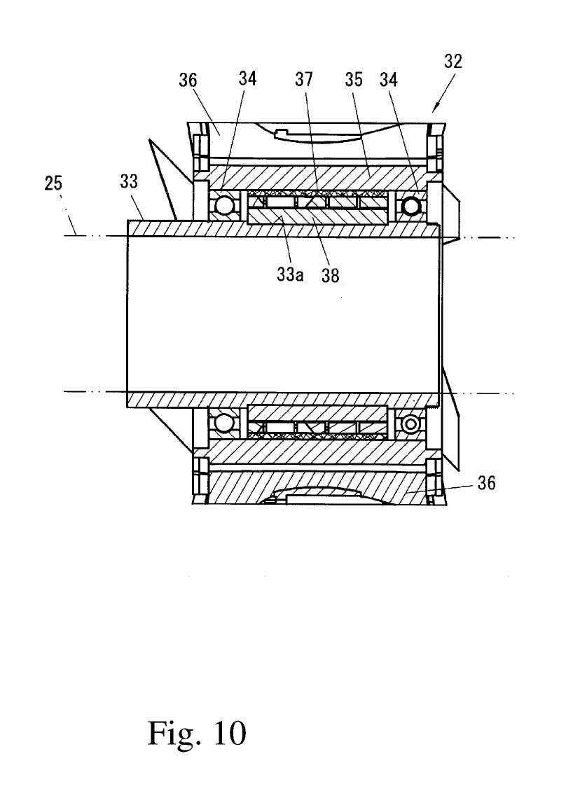

The impeller 32, as shown in FIGS. 9 and 10, includes a cylindrical support member 33 supported by the shaft section 25 by inserting the shaft 25 therethrough, and a cylindrical rotary body 35 disposed on the support member 33, and provided to be rotatable about an axis through a bearing 34, and a plurality of blades 36 provided on the outer peripheral surface of the rotary body 35.

The length of the support member 33 in the axial direction is longer than that of the rotary body 35. Further, one end of the support member 33 (the left end in FIG. 10) protrudes leftward from one end of the rotary member 35, while the other end of the support member 33 (right end in FIG. 10) is substantially flush with the other end of the rotary member 35. The shaft section 25 is inserted through such a support member 33, so that the support member 33 can be fixed to the shaft section 25.

The outer race of the bearing 34 is fitted to the inner peripheral surface at both end portions of the rotary body 35, and the inner race thereof is fitted to the outer peripheral surface of the support member 33. Therefore, the rotary body 35 is supported by the bearings 34, 34 and is rotatable around the axis.

The blades 36 are inclined with respect to the axis of the rotary body 35 and are arranged at equal intervals in the circumferential direction. In this way, the blades 36 will rotate together with the rotary body 35 by receiving the wind from the front end side of the rotary body 35.

A permanent magnet 37 is provided on the inner peripheral surface of the rotary body 35. Further, on the outer peripheral surface of the support member 33, a recess 33a is formed extending along the circumferential direction, and a cylindrical coil 38 is provided in the recess 33a with a predetermined gap from the permanent magnet 37.

Then, the rotary body 35 rotates together with the impellers 32 by the wind, so that the permanent magnet 37 also rotates. Accordingly, an electricity is generated by collaboration between the permanent magnet 37 and the coil 38.

On the other hand, the electricity so generated is taken out from the coil 38 and stored in the battery or directly used. Further, since a plurality of impellers 32 are provided on the shaft section 25, electricity can be generated through collaboration between the permanent magnet 37 and the coil 38 of each impeller 32, and is stored in the battery or used directly.

Although a plurality of such impellers 32 are attached to the shaft section 25, since one end of the support member 33 protrudes from one end of the rotary body 35, the blades 36, 36 of the impellers 32, 32 adjacent to each other in the axial direction will not interfere with each other. Namely, regarding the mutually adjacent impellers 32, 32, the protruding one end of the support member 33 of one impeller 32 will be abutted by the other non-protruding end of another impeller 32. Accordingly, it is possible to ensure an interval which will not cause a mutual interference between the blades 36, 36 of mutually adjacent impellers 32, 32.

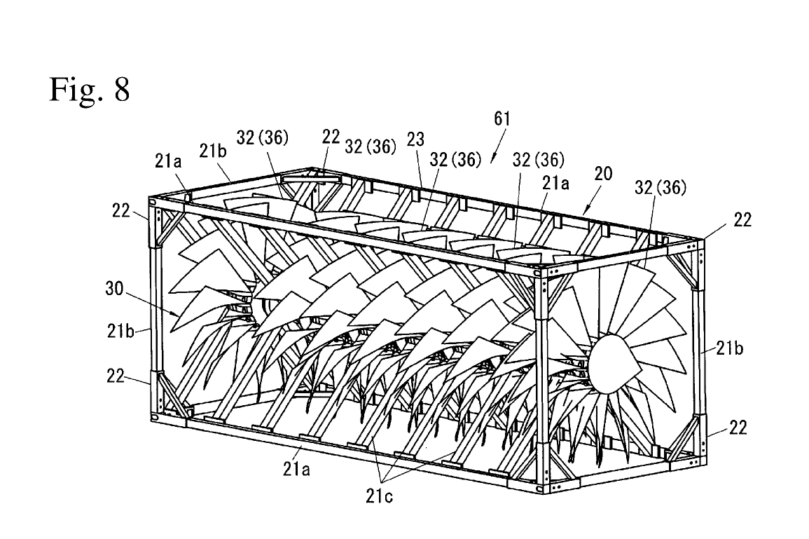

As shown in FIGS. 7 and 8, the wind power generation device 30 accommodated in the storage unit 20 is configured such that its leading impeller 32 is positioned at front end side of the storage unit 20 (right end side in FIG. 7 and FIG. 8), while its trailing impeller 32 is located at the rear end side (left end in FIG. 7 and FIG. 8). Namely, in the storage unit 20, as many impellers 32 as possible are accommodated coaxially along the longitudinal direction (axial direction) thereof.

A plurality of such wind power generation units 61 may be formed into an assembly 60 including these wind power generation units, by joining the structural material joints 22 of the storage units 20 and joining the structural materials 21a, 21a and the structural materials 21b, 21b that are in contact with each other, thereby constituting an assembly 60 of wind power generation units. On the other hand, it should be noted that although it is preferable to effect the above-mentioned joining by means of bolt tightening, such joining may also be completed by welding or the like.

The wind power generation equipment including the wind collection apparatus 1 and the wind power generation unit assembly 60 is installed, for example, in mountainous areas, islands, and the like. At this time, the front side of the wind collection apparatus 1 is installed facing the direction in which the wind blows.

Since the wind power generation unit assembly 60 is provided on the rear lower side of the wind collection apparatus 1, the wind collected by the wind collection apparatus 1 is increased in its velocity by the wind collecting section 2, and is discharged through the wind outlet 5 of the wind collection apparatus 1. Then, the discharged wind enters from the distal end face of each wind power generation unit 61 and turns the impellers 32, so that electricity is generated by collaboration between the permanent magnet 37 and the coil 38.

In addition, the wind collection apparatus 1 is used not only for power generation, but can also be used in the following cases. For example, by installing the wind collection apparatus 1 in a large city and providing various filters at the wind outlet 5 of the wind collection apparatus 1, it is possible to use the filters to remove contaminants from an exhaust polluted air of large city collected by wind collection apparatus 1. In this way, it is possible to adjust the quality of air so as to provide a clean city air.

Further, an air compressor can be installed at the wind outlet 5 of the wind collection apparatus 1. The air compressor can be rotated (operated) by the air discharged from the wind outlet 5, and stored in a high pressure tank to produce oxygen.

Since the wind power generation equipment according to the present embodiment includes the wind collection apparatus 1 and the wind power generation device 30 connected to the wind outlet 5 of the wind collection apparatus 1, it is possible to reduce the height of the wind by the wind collecting section 2 of the wind collection apparatus 1 and narrow down the volume of the normal pressure wind to a high density and high pressure wind, followed by effectively discharging the wind from the wind outlet 5. As a result, it is possible to effectively generate electricity by using the wind and the wind power generation device 30.

In addition, since a plurality of impellers 32 are provided inside the cylindrical body 31, the impellers 32 can be efficiently rotated by allowing wind to flow into the cylindrical body 31. Thus, electricity can be generated through collaboration between the permanent magnet 37 and the coil 38. Further, since the blades can be made smaller than conventional wind power generation unit, it is possible to install the wind power generation equipment in a space-saving manner. In addition, since the cylindrical body 31 is less susceptible to an influence from the surrounding wind, it is possible to suppress the noise, and the appearance thereof can also be made more acceptable. In the present embodiment, the body 31 is cylindrical, but it is not limited to this. For example, the cylindrical body 31 may be a polygonal cylindrical shape such as quadrangular cylindrical shape, an elliptical cylindrical shape, or an oval cylindrical shape, provided that it is cylindrical. Further, the cylindrical body 31 is not limited to a linear shape, but may be a curved one. In this way, it is also possible to actively divert the direction of a wind flow to blow away contaminated air of large city to a desired place. Moreover, a plurality of shafts extending in the axial direction may be provided inside the cylindrical body 31, and a plurality of impellers 32 may be attached onto these shafts.

In addition, since the impellers 32 are provided inside the cylindrical body 31, the wind (air) striking the impellers 32 will not escape to the outside and thus the wind pressure does not decrease. Therefore, the wind will efficiently bump into all the impellers 32, thereby ensuring a power generation at a high efficiency.

Further, since each impeller 32 includes a support member 33 positioned on the shaft portion 25, and a rotator 35 rotatably provided via the bearing 34 on the support member 33 and having blades 36 on the outer peripheral portion thereof, it is possible to easily increase or decrease the number of the impellers 32 provided on the shaft portion 25. Accordingly, it is possible to easily adjust the ability of the wind power generation device 30 in response to a wind force and a wind volume.

In addition, since the wind power generation device 30 is housed in the storage unit 20, it is possible to protect the wind power generation device 30 by means of the storage unit 20, making it possible to easily set the wind power generation device 30 at a desired place. Besides, it is possible to easily transport the wind power generation device 30 and ensure an easy handling of the device at the installation site.

Since the leading impeller 32 of the wind power generation device 30 is positioned on the front end side of the storage unit 20, wind is received from the front end face and easily flows into the cylindrical body 31, thereby rotating the impellers 32.

Further, by stacking the storage units 20 or laterally connecting them, it is possible to easily adjust the installation number and the installation position of the wind power generation units 61.

In addition, since the front end face of the storage unit 20 of the wind power generation unit 61 is connected to the wind outlet 5 of the wind collection apparatus 1, the wind taken into the wind collection apparatus 1 is collected and discharged from the wind outlet 5, allowing the discharged wind to flow from the front end face of the storage unit 20 into the cylindrical body 31. In this way, it is possible to efficiently supply the wind to the wind power generation device 30 and thus generate electric power.

In addition, the wind volume of the natural environment is reduced (wind cutting) on the front side of the wind collecting section 2, and then collected into the rear side of the wind collecting section 2, followed by being sent therefrom. Here, since the wind outlet 5 is provided below the upper end of the front surface of the wind collecting section 2, and the wind flow passage cross section of the wind collecting section 2 becomes smaller from the front side toward the rear side, the height of the wind is lowered and the volume of the wind at normal pressure can be narrowed down to a high density and high pressure wind, followed by being discharged through the wind outlet 5. Since the wind discharged through the wind outlet 5 becomes high density and high pressure and is rectified at the same time, this flow is introduced into the cylindrical body 31 and continuously bumps into a plurality of impellers 32 coaxially provided inside the cylindrical body 31, thereby rotating the impellers 32 and thus efficiently generating electricity.

Further, by rotating the impellers 32, an air compressor can be operated, the compressed air can be stored in a high pressure tank, and then used in a compression air vehicle. Besides, an oxygen compressor can be operated to store oxygen in an oxygen tank.

Moreover, by providing a filter at the wind outlet 5, it is possible to remove foreign matters such as dust contained in the wind (air) taken into the wind collecting section 2, thereby generating an electricity and purifying the air.

In addition, it is also possible to use the wind collection apparatus 1 separately from the wind power generation unit assembly 60. In this case, it is possible to produce drinking water in an island or the like where there is little rainwater, by providing an air filter at the wind outlet 5 of the wind collecting section 2 of the wind collection apparatus 1 and collecting a moisture. Furthermore, it is also possible to weaken the force of typhoon by removing the moisture from the wind.

In addition, since the relatively heavy wind power generation unit assembly 60 is provided on the lower face on the rear side of the wind collection apparatus' and is installed on the ground, it is possible to stably install the wind collection apparatus 1, and makes it easy to perform the maintenance or the like on the wind power generation device 30 in each wind power generation unit 61.

Further, it is also possible to have a configuration in which the wind power generation equipment is installed on a turn-table or the like which is rotatable by a driving source such as a motor or the like, and an electricity generated by the wind power generation device 30 is supplied to the driving source, so that the wind power generation equipment can be turned around the vertical axis by virtue of the turn table, and a turning angle thereof may be controlled. In this way, the wind power generation equipment can be easily controlled in a manner such that the front side of the wind collection apparatus 1 can be directed toward the wind blowing direction, thereby ensuring an efficient power generation.

### EXPLANATION OF REFERENCE NUMERALS

1 wind collection apparatus
2 wind collecting section
3 side wall portion
4 upper wall portion
5 wind outlet
6 upper wall body
7 support frame
10 support column
12 cable
25 shaft portion
30 wind power generation device
31 cylindrical body
32 impeller
33 support member
34 bearing
35 rotary body
36 blades
37 permanent magnet
38 coil
60 wind power generation unit assembly
61 wind power generation unit

1. A wind collection apparatus comprising a wind collecting section for collecting wind taken from a front surface side into an outlet provided on a rear surface side,
wherein:
the outlet is provided below an upper end of the front surface of the wind collecting section;
the wind collecting section is configured such that a cross section of wind flow passage becomes smaller from the front surface side toward the rear surface side;
the wind collecting section has a pair of left and right side wall portions and an upper wall portion bridged between the pair of side wall portions;
a plurality of support columns are arranged to penetrate the upper wall portion;
upper end portion of each support column and the upper wall portion are connected to each other by cables; and
upper wall portion is suspended by the cables.

2. The wind collection apparatus according to claim 1, wherein
the pair of side wall portions are arranged to be closer to each other from the front surface side toward the rear surface side; and
the upper wall portion is disposed to be inclined downward from the front surface side toward the rear surface side.

3. The wind collection apparatus according to claim 1, wherein
the upper wall portion includes a plate-like upper wall main body and a support frame fixed to an upper surface of the upper wall main body; and
cables are connected to the support frame.

4. A wind power generation equipment, comprising:
a wind collection apparatus according to claim 1; and
wind power generation device connected to the wind outlet of the wind collection apparatus.

5. The wind power generation equipment according to claim 4, wherein
the wind power generation device includes: a cylindrical body; a shaft portion provided inside the cylindrical body in an axial direction of the cylindrical body; and a plurality of impellers which are coaxial with the shaft portion and provided inside the cylindrical body in the axial direction of the shaft portion;
each impeller includes: a cylindrical support member supported by a shaft portion by inserting the shaft portion; a rotary body rotatably provided on the support member around the shaft via a bearing; and a plurality of blades provided on an outer peripheral portion of the rotary body,
wherein a permanent magnet is provided on one of the support member and the rotary body, and a coil is provided on the other of the support member and the rotary body, with a predetermined gap formed between the coil and the permanent magnet.
